(19) United States
(12) Patent Application Publication
(10) Pub. No.: US 2014/0333516 A1
(43) Pub. Date: Nov. 13, 2014

(54) DISPLAY DEVICE AND DRIVING METHOD THEREOF

(71) Applicant: Samsung Display Co., Ltd., Yongin-City (KR)

(72) Inventors: Dong-Won Park, Hwaseong-si (KR); Joon-Chul Goh, Hwaseong-si (KR); Nam-Gon Choi, Asan-si (KR); Jung-Won Kim, Seoul (KR); Bong Hyun You, Yongin-si (KR); Bum Soo Lee, Bucheon-si (KR)

(73) Assignee: Samsung Display Co., Ltd., Yongin-city (KR)

(21) Appl. No.: 14/017,119

(22) Filed: Sep. 3, 2013

(30) Foreign Application Priority Data
May 8, 2013 (KR) 10-2013-0052021

(51) Int. Cl. G09G 3/36

(52) U.S. Cl. CPC G09G 3/3648
USPC 345/89

(57) ABSTRACT

A display device and a driving method thereof are disclosed. In one aspect, the display device includes: a memory which receives an input image data at a first frame frequency and a frame rate controlling unit which converts the input image data to an output image data output at a second frame frequency higher than the first frame frequency by duplicating the input image data to a plurality of frames. The display device also includes a release frame inserting unit which periodically designates release frames in the output image data for resolving a DC bias of one or more continuous frames and a data compensating unit which compensates for a value of the output image data or determines the value of the output image data.

### CROSS-REFERENCE TO RELATED APPLICATIONS

This application claims priority to and the benefit of Korean Patent Application No. 10-2013-0052021 filed in the Korean Intellectual Property Office on May 8, 2013, the entire contents of which are incorporated herein by reference.

### BACKGROUND

1. Field

The described technology generally relates to a display device and a driving method thereof

2. Description of the Related Technology

Displays, such as liquid crystal displays (LCD) or organic light-emitting diode (OLED) displays, generally include a display panel and a driving device for driving the display panel.

Typically, display panels include a plurality of signal lines, and a plurality of pixels connected to the signal lines arranged in an approximate matrix form.

The signal lines include a plurality of gate lines which transmit gate signals, and a plurality of data lines which transmit data voltages.

Each pixel may include at least one switching element connected to a corresponding gate line and a corresponding data line, at least one pixel electrode connected to the at least one switching element, and an opposing electrode facing the pixel electrode which receives a common voltage. The switching element may include at least one thin film transistor, and may be turned on or turned off according to a gate signal transmitted by the gate line. The switching element may selectively transmit a data voltage transmitted by the data line to the pixel electrode according to the gate signal. Each pixel may display an image having corresponding luminance according to a difference between a data voltage applied to the pixel electrode and the common voltage. A difference between the data voltage applied to the pixel electrode and the common voltage is referred to a pixel charging voltage, or a pixel voltage.

For example, a liquid crystal display may include two display panels including a pixel electrode and an opposing electrode, and a liquid crystal display having dielectric anisotropy. The pixel electrodes are arranged in a matrix form, and are connected to the switching element, such as a thin film transistor (TFT), to sequentially receive a data voltage for each line. The opposing electrode is formed on an entire surface of the display panel, and receives a common voltage. An electric field is generated in a liquid crystal layer by applying a voltage to the pixel electrode and the opposing electrode which adjusts the transmittance of light through the liquid crystal layer by adjusting an intensity of the electric field, thereby obtaining a desired image. The luminance of the image displayed by the pixel of the display device may be varied according to a difference between the voltage of the pixel electrode and the common voltage of the opposing electrode.

The driving device may include a gate driver which generates a gate signal, a data driver which generates a data voltage, a gray reference voltage generating unit which supplies a gray reference voltage to the data driver, and a signal controller which controls the gate driver, the data driver, and the gray reference voltage generating unit. The drivers may be directly mounted on a display panel in a form of at least one integrated circuit chip; may be mounted on a film, such as a flexible printed circuit film, to be attached to a display panel in a form of a TCP; or may also be integrated on the display panel together with the signal line and the thin film transistor.

The driving device may convert a digital input image signal including gray level information input from an external system to an analog image signal by using a gray voltage and supply the converted analog image signal to each pixel, thereby displaying an image. The gray voltage is a voltage selected as a data voltage in response to the gray level of an input image signal, and is varied according to the gray level and gamma data specifying the luminance of the image.

The gray voltage may include a positive gray voltage and a negative gray voltage based on the common voltage. The gray voltage may be generated from the positive and negative gray reference voltages having a number smaller than the number of gray voltages.

The gray reference voltage generating unit may generate the positive and negative gray reference voltages by receiving a power voltage or a reference voltage and dividing the voltages.

The data driver may generate a gray voltage for a whole gray level by receiving the positive and negative gray reference voltages from the gray reference voltage generating unit and dividing the received positive and negative gray reference voltages. The data driver may select a gray voltage corresponding to an input image signal from the plurality of gray voltages, and apply the selected gray voltage to the data line as a data voltage.

The data voltage may be applied to the pixel electrode through the switching element. Polarity of the common voltage of the data voltage may be inverted for each predetermined number of frames. However, when the switching element of the pixel is turned off, the pixel voltage may be dropped by a kick-back voltage due to a parasitic capacitance between terminals of the switching elements. The kick-back voltage may be changed according to the gray level, or various factors, such as a leakage current of the thin film transistor by a process deviation between the display panels or regions, a signal delay of a wiring, or when using a liquid crystal display, a deviation of capacitance variation of the liquid crystal condenser according to a data voltage or a temperature change. In this case, a deviation in the voltage actually charged in the pixel is generated between the case where the polarity for the common voltage of the data voltage applied to the pixel is the positive polarity and the case where the polarity for the common voltage of the data voltage applied to the pixel is the negative polarity. Accordingly, when an image is displayed, charge may be collected at either the pixel electrode or the opposing electrode, and a direct current (DC) bias (also referred to as residual DC) is generated resulting in the generation of an afterimage,

The above information disclosed in this Background section is only intended to enhance understanding of the background of the described technology and therefore it may contain information that does not form prior art already known in this country to a person of ordinary skill in the art.

### SUMMARY OF CERTAIN INVENTIVE ASPECTS

The described technology has been developed in an effort to prevent the generation of an afterimage caused by a DC bias by resolving the DC bias generated due to an accumulation of charge at either a pixel electrode or an opposing electrode. The display device may display an image by generating an electric field between two electric field generating electrodes including the pixel electrode and the opposing electrode.

One inventive aspect is a display device including: a memory which receives an input image data at a first frame frequency; a frame rate controlling unit which converts the input image data to an output image data output at a second frame frequency higher than the first frame frequency by duplicating the input image data to a plurality of frames; a release frame inserting unit which periodically designates release frames in the output image data for resolving a DC bias of one or more continuous frames; and a data compensating unit which compensates for a value of the output image data or determines the value of the output image data.

The release frame may have a frequency of approximately 75 Hz or more.

The value of the output image data of the release frame may be determined in consideration of a magnitude of the DC bias in a frame positioned between the adjacent release frames.

A polarity of the output image data of the release frame may be determined in consideration of a polarity of the DC bias in a frame positioned between adjacent release frames.

The polarity of the output image data of the release frame may be opposite to the polarity of the DC bias in the frame positioned between the adjacent release frames.

The display device may further include: a display panel including a plurality of pixels; and a backlight unit which provides light to the display panel, in which the backlight unit is turned off or decreases luminance during the release frame.

The display device may further include: a signal controller which receives the value of the output image data determined in the data compensating unit as an input image signal; and a data driver which receives an output image signal from the signal controller, converts the received output image signal to a data voltage, and outputs the data voltage.

The data driver may be driven by a column inversion driving method.

Another aspect is a method of driving a display device, including: receiving input image data at a first frame frequency; converting the input image data to output image data output at a second frame frequency higher than the first frame frequency by duplicating the input image data to a plurality of frames; periodically designating release frames in the output image data for resolving a DC bias of one or more continuous frames; and compensating for or determining a value of the output image data.

The release frame may have a frequency of approximately 75 Hz or more.

The compensating for or determining of the value of the output image data may include determining the value of the output image data of the release frame in consideration of a magnitude of the DC bias in a frame positioned between adjacent release frames.

The compensating for or determining of the value of the output image data may include determining a polarity of the output image data of the release frame in consideration of a polarity of the DC bias of a frame positioned between adjacent release frames.

The polarity of the output image data of the release frame may be opposite to the polarity of the DC bias in the frame positioned between the adjacent release frames.

The display device may include a display panel including a plurality of pixels, and a backlight unit which provides light to the display panel, and the method may further include turning off or decreasing luminance of the backlight unit during the release frame.

The method may further include receiving the output image data as an input image signal, and converting the received output image data to a data voltage.

A display device may display an image by generating an electric field between a pixel electrode and an opposing electrode. According to at least one of the disclosed embodiments, it is possible to prevent the generation of an afterimage caused by a DC bias in such a display device by resolving the DC bias generated due to accumulation of charge at either the pixel electrode or the opposing electrode.

### BRIEF DESCRIPTION OF THE DRAWINGS

FIG. 1 is a block diagram of a display device according to an exemplary embodiment of the described technology.

FIG. 2 is a block diagram of a data processing unit of the display device according to an exemplary embodiment of the described technology.

FIG. 3 is an example of a waveform diagram of a driving signal of the display device according to an exemplary embodiment of the described technology.

FIG. 4 is a graph illustrating a gray voltage and a common voltage of the display device according to an exemplary embodiment of the described technology.

FIGS. 5 and 6 are waveform diagrams illustrating a driving method of the display device according to an exemplary embodiment of the described technology.

FIGS. 7 and 8 are timing diagrams illustrating the driving method of the display device according to exemplary embodiments of the described technology.

FIG. 9 is a diagram illustrating a number of steps of processing input data in the display device according to an exemplary embodiment of the described technology.

FIGS. 10 to 19 are timing diagrams illustrating input data and release frames of input image signals corresponding to the input data of the display device according to exemplary embodiments of the described technology.

### DETAILED DESCRIPTION OF CERTAIN INVENTIVE EMBODIMENTS

Embodiments will be described more fully hereinafter with reference to the accompanying drawings, in which exemplary embodiments of the described technology are shown. As those skilled in the art would realize, the described embodiments may be modified in various different ways, all without departing from the spirit or scope of the described technology.

A display device according to an exemplary embodiment of the described technology and a driving method thereof will be described in detail with reference to the accompanying drawings.

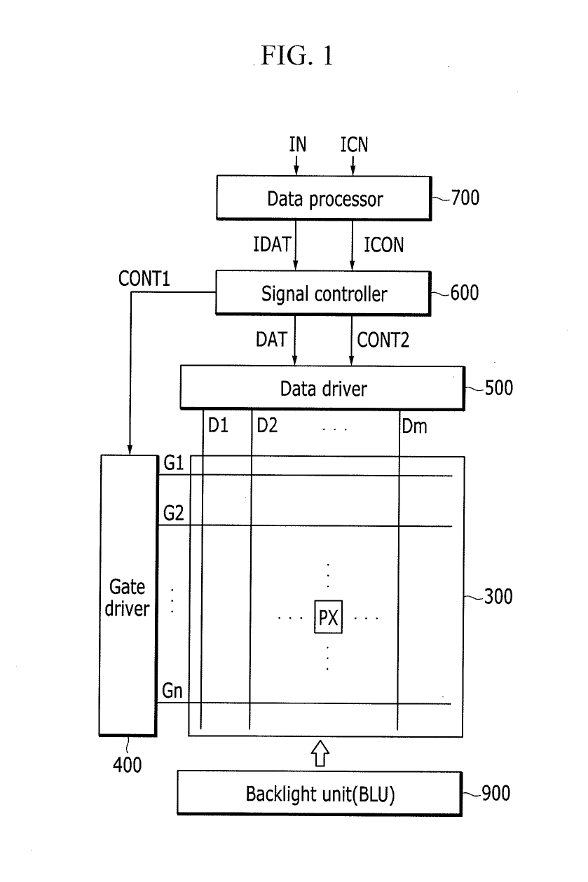

First, referring to FIG. 1, a display device according to an exemplary embodiment of the described technology will be described.

FIG. 1 is a block diagram of a display device according to an exemplary embodiment of the described technology.

Referring to FIG. 1, the display device includes a display panel 300, a gate driver 400 and a data driver 500 connected to the display panel 300, a signal controller 600 for controlling the gate driver 400 and the data driver 500, a data processor 700 connected with the signal controller 600, and the like.

The display panel 300 may be a display panel included in various displays, such as a liquid crystal display (LCD), or an organic light-emitting diode (OLED) display. In the case where the display device is a liquid crystal display, the display panel 300 may include lower and upper display panels (not illustrated) facing each other, and a liquid crystal layer (not illustrated) interposed therebetween based on a cross-sectional view of the display panel 300.

The display panel 300 may include a plurality of signal lines and a plurality of pixels PX connected to the plurality of signal lines and which may be arranged in an approximate matrix form.

The signal lines may include a plurality gate lines G1 to Gn for transmitting gate signals (also referred to as “scan signals”), and a plurality of data lines D1 to Dm for transmitting data voltages. The gate lines G1 to Gn may be extended approximately in a row direction substantially parallel to each other, and the data lines D1 to Dm may be extended approximately in a column direction substantially parallel to each other.

Each pixel PX may include one or more switching elements connected to the one or more gate lines G1 to Gn and the one or more data lines D1 to Dm. Each pixel PX may also include one or more pixel electrodes connected to the one or more switching elements, and an opposing electrode capable of forming an electric field together with the pixel electrode.

The switching element may include at least one thin film transistor, and may be turned on or turned off according to a gate signal transmitted by the gate lines G1 to Gn to selectively transmit the data voltage transmitted by the data lines D1 to Dm to the pixel electrode.

The opposing electrode may receive a common voltage Vcom. The opposing electrode may be positioned on the same substrate as that of the pixel electrode, or may also be positioned on a different substrate from that of the pixel electrode.

Each pixel may display a corresponding luminance of an image according to a difference between the data voltage applied to the pixel electrode and the common voltage Vcom.

In order to implement a color display, each pixel may display one of the primary colors (spatial division), or alternately display a primary color at a predetermined time (temporal division) to allow the desired color to be recognized through a spatial and temporal sum of the primary colors. An example of the primary colors may be three primary colors, such as red, green, and blue. The plurality of adjacent pixels PX displaying the different primary colors may configure one set (referred to as a dot) together. One dot may display a white image.

The gate driver 400 may receive a gate control signal CONT1 from the signal controller 600 to generate a gate signal based on the received gate control signal CONT1. The gate signal may be formed of a combination of a gate-on voltage Von capable of turning on the switching element of the pixel PX and a gate-off voltage Voff capable of turning off the switching element of the pixel PX. The gate control signal CONT1 may include a scan start signal STV indicating a start of scanning, a gate clock signal CPV controlling an output timing of the gate-on voltage Von, and at least one low voltage. The gate driver 400 is connected to the gate lines G1 to Gn of the display panel 300 to apply the gate signal to the gate lines G1 to Gn.

The data driver 500 may generate an output image signal DAT as a data voltage that is an analog data signal by receiving a data control signal CONT2 and the output image signal DAT from the signal controller 600 and selecting a gray voltage corresponding to each output image signal DAT. The data control signal CONT2 may include a horizontal synchronization start signal which indicates a start of a transmission of the output image signal DAT for the pixels PX of one row, a load signal which instructs an application of the data voltage to the data lines D1 to Dm, and the like. The data control signal CONT2 may also further include an inversion signal which inverts polarity of the data voltage for the common voltage Vcom. The data driver 500 may be connected with the data lines D1 to Dm of the display panel 300 to apply the data voltage to the corresponding data lines D1 to Dm.

The signal controller 600 may receive an input image signal IDAT and an input control signal ICON which controls a display of the input image signal IDAT from the data processor 700. The input image signal IDAT may contain luminance information of each pixel PX, and the luminance has a predetermined number of gray levels, for example, 1024=2¹⁰ gray levels, 256=2⁸ gray levels, or 64=2⁶ gray levels. An example of the input control signal ICON includes a vertical synchronization signal VSync, a horizontal synchronization signal HSync, a main clock signal, a data enable signal, and the like.

The signal controller 600 may appropriately process the input image signal IDAT based on the input image signal IDAT and the input control signal ICON and convert the input image signal IDAT to the output image signal DAT. The signal controller 600 may generate the gate control signal CONT1 and the data control signal CONT2 based on the input image signal IDAT and the input control signal ICON. The signal controller 600 may transmit the gate control signal CONT1 to the gate driver 400, and transmit the data control signal CONT2 and the processed output image signal DAT to the data driver 500.

The data processor 700 may generate the input image signal IDAT and the input control signal ICON by receiving input image data IN and control data ICN from the outside and processing the received input image data IN and control data ICN. The data processor 700 may transmit the input image signal IDAT and the input control signal ICON to the signal controller 600.

The display device according to an exemplary embodiment of the described technology may further include a backlight unit (BLU) 900 which provides light to the display panel 300.

A display driving method of the display device will now be described.

The signal controller 600 may receive the input image signal IDTA and the input control signal ICON which controls a display of the input image signal IDAT from the outside. The signal controller 600 may process the input image signal IDAT based on the input image signal IDAT and the input control signal ICON to convert the input image signal IDAT to the output image signal DAT, and generate the gate control signal CONT1, the data control signal CONT2, and a gamma control signal CONT3. The signal controller 600 may transmit the gate control signal CONT1 to the gate driver 400, and transmit the data control signal CONT2 and the output image signal DAT to the data driver 500. The data control signal CONT2 may further include an inversion signal which inverts polarity of the data voltage for the common voltage Vcom.

The data driver 500 may receive the output image signal DAT for the pixels PX of one row according to the data control signal CONT2 received from the signal controller 600, convert the output image signal DAT to the analog data voltage by selecting a gray voltage corresponding to each output image signal DAT, and then apply the converted analog data voltage to the data lines D1 to Dm. The gray voltage may include a positive gray voltage and a negative gray voltage based on the common voltage Vcom.

The gate driver 400 may turn on the switching elements connected to the gate lines G1 to Gn by applying the gate-on voltage Von to the gate lines G1 to Gn according to the gate control signal CONT1 received from the signal controller 600. Then, the data voltages applied to the data lines D1 to Dm may be applied to the corresponding pixels PX through the turned-on switching elements.

When the data voltage is applied to the pixels PX, the pixels PX may display luminance corresponding to the data voltage through various optical conversion devices. A difference between the data voltage applied to a pixel PX and the common voltage Vcom is represented as a charging voltage of the pixel, that is, a pixel voltage. In the case where the data voltage applied to the pixel PX has a positive polarity based on the common voltage Vcom, the pixel voltage is referred to as a positive pixel voltage. Likewise, in the case where the data voltage applied to the pixel PX has a negative polarity based on the common voltage Vcom, the pixel voltage is referred to as a negative pixel voltage.

For example, when using a liquid crystal display, the difference between the data voltage applied to the pixel PX and the common voltage Vcom is represented as a charging voltage, that is, a pixel voltage, of a liquid crystal condenser. Liquid crystal molecules are changed in an arrangement thereof according to a magnitude of the pixel voltage, and thus polarization of light passing through the liquid crystal layer is changed. A change in the polarization is represented by a change in transmittance of light by at least one polarizer separately attached to the display device, and each pixel PX may display luminance through the change in the transmittance of the light corresponding to a gray level of the input image signal. [0065] The gate-on voltage Von may be sequentially applied to all of the gate lines G1 to Gn and the data voltage may be applied to all of the pixels PX by repeating the aforementioned process by a unit of a 1 horizontal period (written as “1H”, which is the same as one period of the horizontal synchronization signal HSync and the data enable signal DE), to display an image of one frame.

When one frame is completed, a next frame is started, and a state of the inversion signal included in the data control signal CONT2 may be controlled so that the polarity of the data voltage applied to the each pixel PX becomes opposite to the polarity of a previous frame (referred to as a frame inversion). During the frame inversion, the polarity of the data voltages applied to all of the pixels PX may be inverted for each of one or more frames. The polarity of the data voltage flowing through one data line D1 or Dm may be periodically changed according to a characteristic of the inversion signal even within one frame, or the polarities of the data voltages applied to the data lines D1 to Dm of one pixel row may be different from each other. Particularly, column inversion driving is the driving of inverting the polarities of the data voltages of the adjacent data lines D1 to Dm for each at least one data line D1 or Dm while uniformly maintaining the polarities of the data voltages applied to the data lines D1 to Dm during one frame.

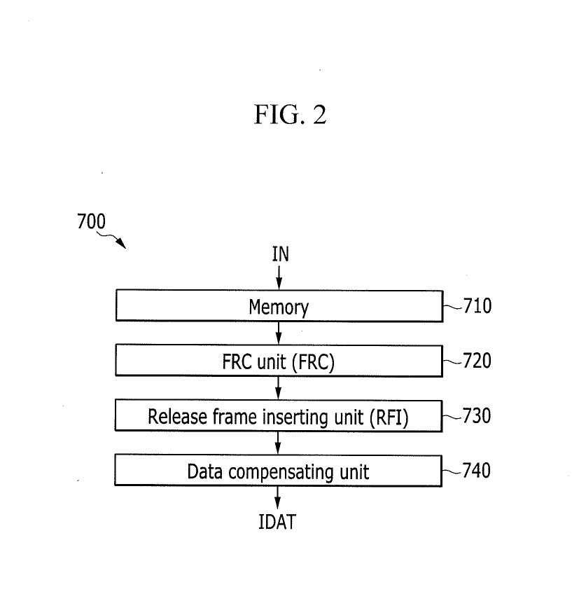

Next, the data processor 700 according to an exemplary embodiment of the described technology will be described in detail with reference to FIGS. 2 to 4 together with FIG. 1.

FIG. 2 is a block diagram of a data processor of the display device according to an exemplary embodiment of the described technology.

Referring to FIG. 2, the data processor 700 include a memory 710, a frame rate controlling unit (FRC unit or a frame rate controller) 720, a release frame inserting unit 730, and a data compensating unit (or a data compensator) 740.

The memory 710 may receive input image data IN from the outside and store the received input image data IN. The input image data IN may be input at a predetermined input frame frequency. The frame frequency is the number of frames of an image displayed on a screen during one second, and the frame frequency is measured in units of Hz. The frame frequency is also referred to as a frame rate. For example, the input image data IN may be input at an input frame frequency of 60 Hz. The memory 710 may have a capacity capable of storing image data larger than one frame and smaller than two frames.

The frame rate controlling unit 720 may frame-rate convert the input image data IN to output image data (hereinafter, simply referred to as image data) having an output frame frequency, which is a higher frequency than the input frame frequency, by duplicating the input image data IN stored in the memory 710 to two or more frames. When the output frame frequency is frame-rate converted to N times the input frame frequency (N is a natural number equal to or larger than 2), the input image data IN of one frame is converted to image data of N frames. Particularly, the generation of the first frame of the frame-rate converted image data may be completed at a time at which the input of the input image data IN is completed, and the second frame to the last frame of the frame-rate converted image data may be sequentially generated after the input of the input image data IN is completed.

In some embodiments, the memory 710 may need to store the input image data IN for a subsequent predetermined time, in addition to the frame in which the input image data IN is input. Here, the predetermined time is a time longer than 0 frames and shorter than 1 frame.

The release frame inserting unit 730 may designate a release frame in the frame-rate converted image data. The release frame is a frame for releasing and recovering residual direct current (DC), that is, a DC bias accumulated during the display time of the image throughout several previous frames.

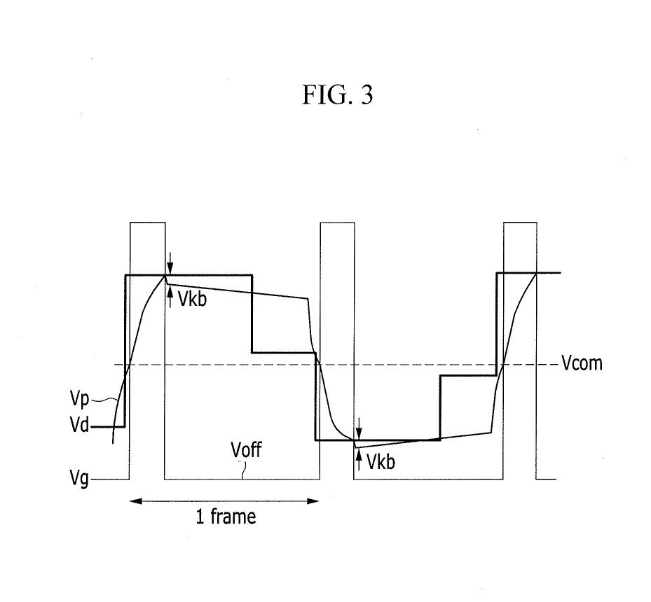

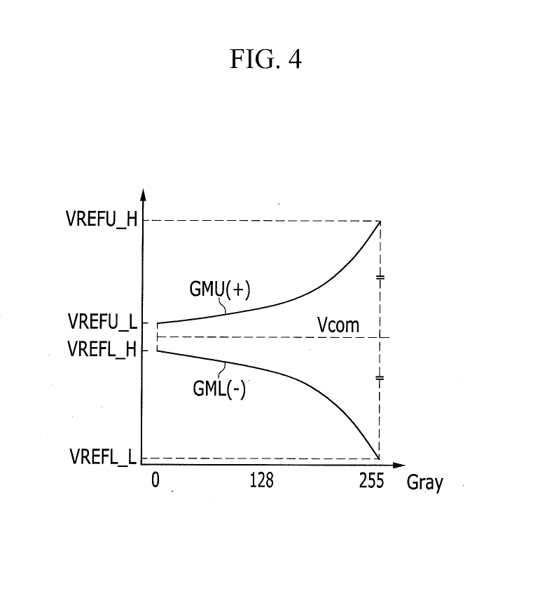

The concept discussed above will be described in detail below with reference to FIGS. 3 and 4.

FIG. 3 is an example of a waveform diagram of a driving signal of the display device according to an exemplary embodiment of the described technology, and FIG. 4 is a graph illustrating the gray voltage and the common voltage of the display device according to an exemplary embodiment of the described technology.

Referring to FIG. 3, when a data voltage Vd is applied to the data lines D1 to Dm, and a gate signal Vg applied to the gate lines G1 to Gn is the gate-on voltage Von, a pixel voltage Vp of each pixel PX is changed toward a target data voltage. Next, when the gate signal Vg is dropped to the gate-off voltage Voff, the pixel voltage Vp is dropped by a kick-back voltage Vkb caused by a parasitic capacitance between the terminals of the switching elements, especially, a parasitic capacitance between the pixel electrode and the gate lines G1 to Gn. Accordingly, the changed pixel voltage Vp may be substantially maintained during the remaining time of the frame. A magnitude of the kick-back voltage Vkb may be changed according to the gray level.

Accordingly, as illustrated in FIG. 4, when a positive gray voltage curved line GMU is substantially symmetric to a negative gray voltage curved line GML, and the common voltage Vcom applied to the opposing electrode is substantially constant according to the gray level, a deviation of the actual pixel voltage Vp is generated between the case where the polarity of the common voltage Vcom of the data voltage Vd applied to the pixel PX is positive (+) and the case where the polarity of the common voltage Vcom of the data voltage Vd applied to the pixel PX is negative (−). The negative and positive gray voltage curved lines and an optimum common voltage is set so as to prevent the generation of a deviation in the pixel voltage. However, the deviation of the kick-back voltage may still be generated by a leakage current of the thin film transistor due to a process deviation between the display panels 300 or the regions, a signal delay of a wiring, or when using a liquid crystal display, a deviation such as a change in a capacitance of the liquid crystal condenser according to a change in a data voltage or a change in temperature, and thus a deviation in the actual pixel voltage may be generated. Accordingly, when an image is displayed for several frames, charge may be collected at either the pixel electrode or the opposing electrode, and a DC bias is generated, resulting in the generation of an afterimage. [0078] Referring to FIG. 2 again, the release frame is a frame for releasing DC bias, and may be substantially periodically designated for every two or more frames, and the release frame frequency may be substantially equal to or higher than approximately 75 Hz, which is a frequency limit at which a person is able to recognize flicker.

The length of one release frame may be substantially the same as or different from the length of another frame. The length of one release frame may be appropriately set according to a condition of the display panel 300.

The data compensating unit 740 may generate the input image signal IDAT by compensating for and determining the frame-rate converted image data, and then transmit the input image signal IDAT to the signal controller 600.

In the case of using a liquid crystal display, the compensation of image data of a general frame, other than the release frame, may include various compensation processings, such as a dynamic capacitance compensation (DCC) for compensating for a response speed, an accurate color capture (ACC) for a color compensation, and a motion estimate motion compensation (MEMC) for decreasing motion blur.

A gray level and a polarity of the image data of the release frame may be determined in consideration of the amount of charge accumulated during frames between adjacent release frames, a polarity of the residual charge, and the like. Accordingly, in order to determine the image data of the release frame, an algorithm for recognizing image data of a previous frame and determining a magnitude of the DC bias or the amount of accumulated charge, and the DC bias or the polarity of the accumulated charge may be further performed, and a unit which performs the algorithm may be further included in the data processing unit 700.

Further, in the case where the image data of a general frame, other than the release frame, is compensated, compensated image data of another general frame may be referred to when the image data of the release frame is determined.

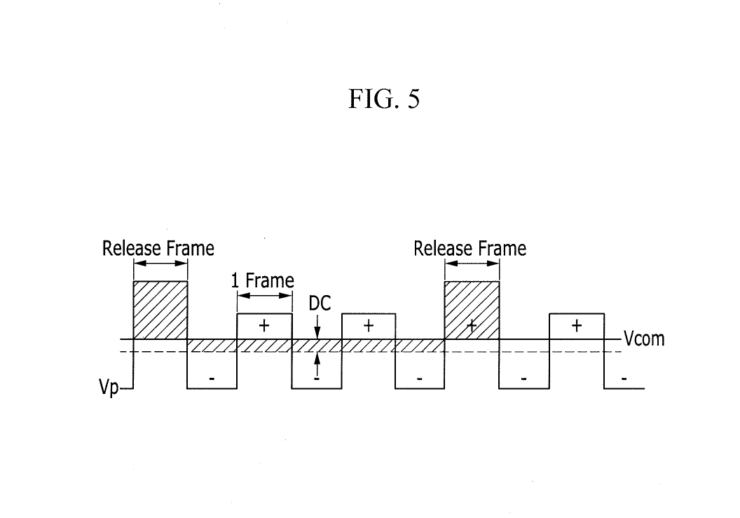

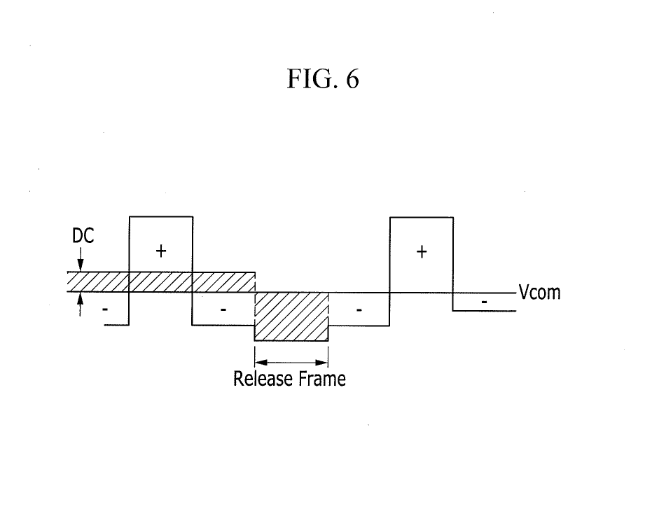

Next, an example of a method for determining the image data of the release frame by the data processing unit 700 of the display device according to an exemplary embodiment of the described technology will be described with reference to FIGS. 5 and 6.

FIGS. 5 and 6 are waveform diagrams illustrating a driving method of the display device according to an exemplary embodiment of the described technology.

First, referring to FIG. 5, one release frame in the display device according to an exemplary embodiment of the described technology may be positioned for every number of frames, for example, one release frame may be positioned for every 6 frames. In this case, the frequency of the release frame is substantially equal to or higher than approximately 75 Hz in consideration of the fact that the frequency limit at which a person is able to recognize flicker is approximately 75 Hz. In this case, when one release frame is positioned for every 6 frames similar to the exemplary embodiment illustrated in FIG. 5, the frequency of an output frame of the image data may be substantially equal to or higher than approximately 450 Hz. A period of the release frame is not limited to one release frame for every 6 frames, but may be varied.

In the case where the display device according to the exemplary embodiment of the described technology is driven by a frame inversion method and the common voltage Vcom applied to the pixels PX is uniform, the polarity of the pixel voltage Vp is inversed for each frame. An image displayed during the 5 frames between adjacent release frames may be a still image or a moving image. FIG. 5 illustrates a case where an image with a predetermined gray level is displayed during the 5 frames as an example.

Referring to FIG. 5, an average of the pixel voltages Vp for the common voltage Vcom during the 5 frames between the adjacent release frames is not 0, but has a negative value due to an influence of the kick-back voltage, and the like, so that a negative DC bias is present. Accordingly, in order to remove the negative DC bias, a gray value having a value corresponding to the residual negative (−) DC bias and having a positive polarity (+) may be determined as image data for a subsequent release frame. The value of the image data of the release frame may be determined based on the residual negative (−) DC bias and the number of frames between the adjacent release frames.

Contrary to this, originally designated image data of the next release frame may be compensated by using data having an opposite polarity capable of removing the DC bias generated during the 6 frames considering the previous release frame and 5 subsequent frames together. For example, the data having the opposite polarity capable of resolving or substantially removing the DC bias generated during the 6 continuous frames including the previous release frame may be added to the originally designated image data of the next release frame.

Referring to FIG. 6, in the case where an average of the pixel voltages Vp for the common voltage Vcom during one or more frames between adjacent release frames is positive (+), image data of the subsequent release frame may be determined or compensated by using negative (−) data having the opposite polarity as described above.

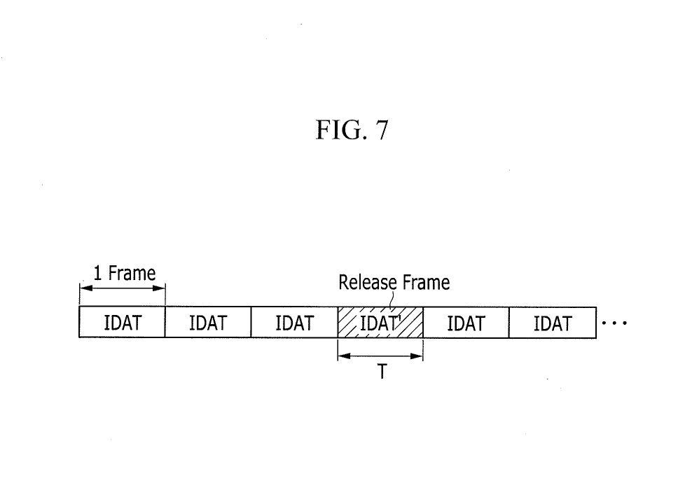

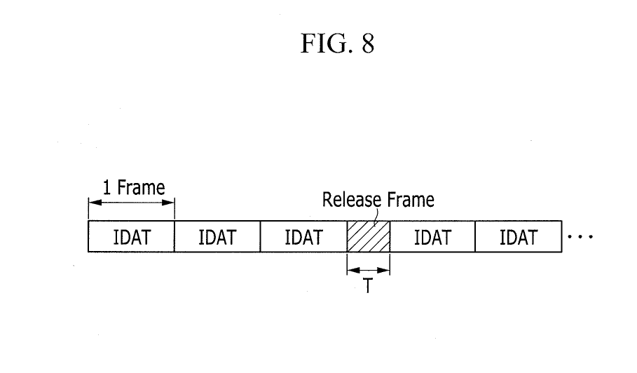

FIGS. 7 and 8 are timing diagrams illustrating a driving method of the display device according to exemplary embodiments of the described technology.

Referring to FIGS. 7 and 8, the input image signal IDAT generated by the data processing unit 700 of the display device according to exemplary embodiments of the described technology includes release frames arranged at a predetermined period. The image input signal IDAT of the release frame is indicated as IDAT′. The length T of one release frame may be the same as the length of another frame indicating the input image signal IDAT as illustrated in FIG. 7, and may also be different from the length of another frame displaying the input image signal IDAT as illustrated in FIG. 8. FIG. 8 illustrates an example in which the length T of the release frame is smaller than the length of another frame.

The length T of the release frame may be appropriately adjusted by the aforementioned data processing unit 700. For example, the length T of the release frame may be appropriately adjusted by any one of the frame rate controlling unit 720, the release frame inserting unit 730, and the data compensating unit 740 of the aforementioned data processing unit 700.

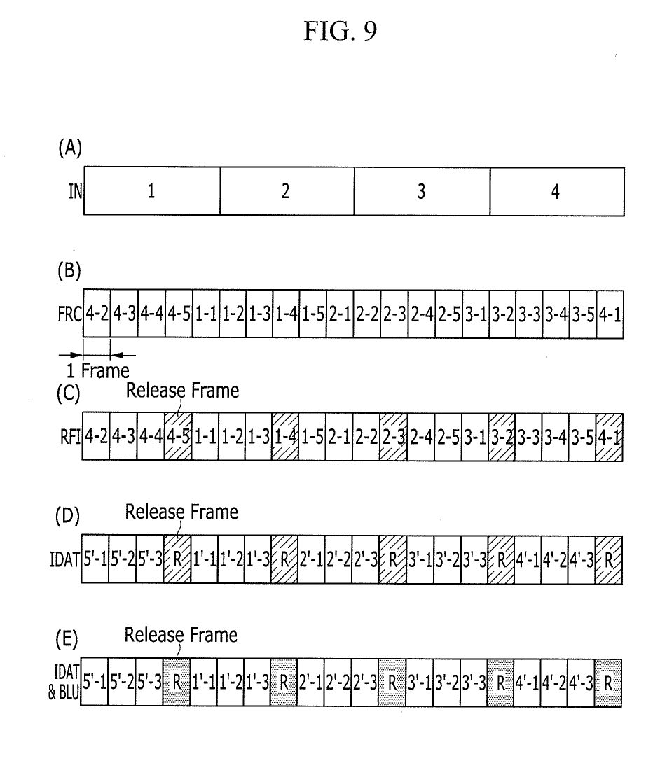

Next, the operation of the data processing unit of the display device according to an exemplary embodiment of the described technology will be described in detail with reference to FIG. 9 together with the aforementioned drawings.

FIG. 9 is a diagram illustrating steps of processing the input data in the display device according to an exemplary embodiment of the described technology.

First, referring to FIG. 9A, the input image data IN is input at a predetermined input frame frequency (for example, 60 Hz).

Next, referring to FIG. 9B, the input image data IN of one frame is duplicated to, for example, 5 frames. Accordingly, the input image data IN is frame-rate converted to image data having an output frame frequency (for example, 300 Hz) which is 5 times that of the input frame frequency (for example, 60 Hz). Particularly, the generation of a first frame 1-1 of the frame-rate converted image data may be completed at a time at which an input of one input image data IN 1 is completed, and the second frame 1-2 to the last frame 1-5 of the frame-rate converted image data may be sequentially generated during the input of input image data IN 2 into the memory 710 after the input of the input image data IN 1 is completed.

Accordingly, in some embodiments, a memory capable of storing the input image data IN 1 of one frame for approximately 1.8 input frames is used.

Next, referring to FIG. 9C, a release frame is designated in the frame-rate converted image data. FIG. 9C illustrates an example in which one release frame is positioned for every 4 frames.

Next, referring to FIG. 9D, the input image signal IDAT including image data R of the release frame and image data 1′-1, 1′-2, . . . , of the remaining frames is generated by compensating for and determining the frame-rate converted image data. The method of compensating for and determining the image data for the release frame and the remaining frames has been previously described, so a detailed description thereof will be omitted.

Next, referring to FIG. 9E, in the case where the display device according to an exemplary embodiment of the described technology includes a backlight unit (BLU), luminance of the backlight unit (BLU) may be reduced or the backlight unit (BLU) may be turned off in order to improve the image quality during the display time of the release frame. In this case, in order to prevent the luminance of a displayed image from being decreased, driving current of the backlight unit (BLU) may be increased for the remaining frames, thereby improving the luminance.

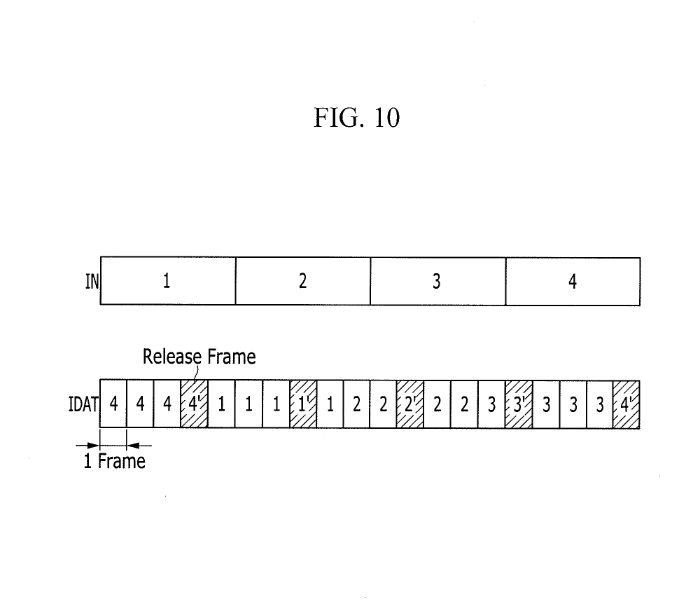

Next, various methods of setting the release frame in the driving method of the display device according to exemplary embodiments of the described technology will be described with reference to FIGS. 10 to 19 together with the aforementioned drawings.

FIGS. 10 to 19 are timing diagrams illustrating input data and release frames of input image signals corresponding to the input data of the display device according to exemplary embodiments of the described technology.

First, referring to FIG. 10, the input image data IN may be input at, for example, an input frame frequency of 60 Hz. Further, the input image data IN may be frame-rate converted to image data at an output frame frequency (for example, 300 Hz), which is 5 times the input frame frequency (for example, 60 Hz) and the input image signal IDAT, by duplicating the input image data IN of one frame to, for example, 5 frames. In this case, one frame for every 4 frames may be designated as a release frame 1′, 2′, 3′, or 4′ in order to prevent the release frame from being driven at a relatively low frequency and recognized as flicker. In this case, the frequency of the release frame is 75 Hz.

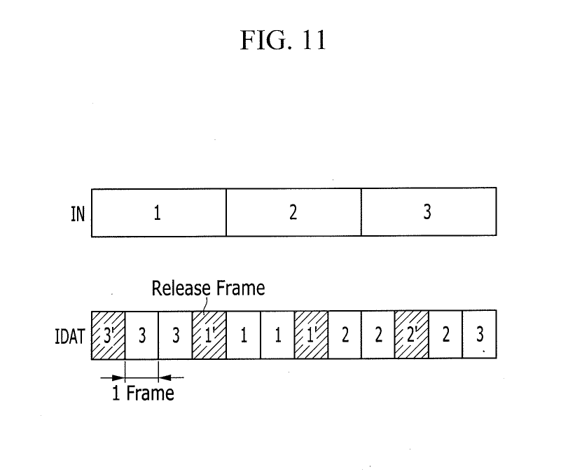

Next, referring to FIG. 11, the input image data IN may be input at an input frame frequency of, for example, 60 Hz. Further, the input image data IN may be frame-rate converted to image data at an output frame frequency (for example, 240 Hz), which is 4 times the input frame frequency (for example, 60 Hz) and the input image signal IDAT, by duplicating the input image data IN of one frame to, for example, 4 frames. In this case, one frame for every 3 frames may be designated as a release frame 1′, 2′, or 3′ in order to prevent the release frame from being driven at a relatively low frequency and recognized as flicker. In this case, the frequency of the release frame is 80 Hz.

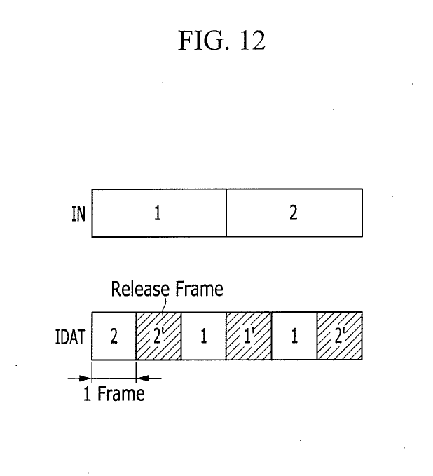

Next, referring to FIG. 12, the input image data IN may be input at an input frame frequency of, for example, 60 Hz. Further, the input image data IN may be frame-rate converted to image data at an output frame frequency (for example, 180 Hz), which is 3 times the input frame frequency (for example, 60 Hz) and the input image signal IDAT, by duplicating the input image data IN of one frame to, for example, 3 frames. In this case, one frame for every 2 frames may be designated as a release frame 1′ or 2′ in order to prevent the release frame from being driven at a relatively low frequency and recognized as flicker. In this case, the frequency of the release frame is 90 Hz.

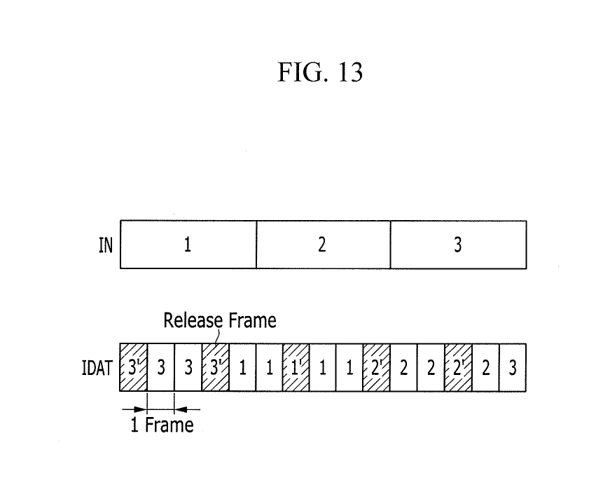

Next, referring to FIG. 13, the input image data IN may be input at an input frame frequency of, for example, 50 Hz. Further, the input image data IN may be frame-rate converted to image data at an output frame frequency (for example, 250 Hz), which is 5 times the input frame frequency (for example, 50 Hz) and the input image signal IDAT, by duplicating the input image data IN of one frame to, for example, 5 frames. In this case, one frame for every 3 frames may be designated as a release frame 1′, 2′, or 3′ in order to prevent the release frame from being driven at a relatively low frequency and recognized as flicker. In this case, the frequency of the release frame is 83.3 Hz.

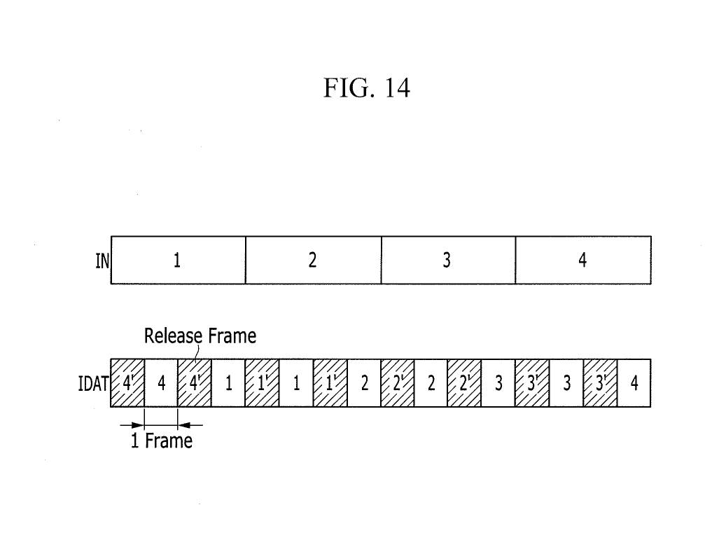

Next, referring to FIG. 14, the input image data IN may be input at an input frame frequency of, for example, 50 Hz. Further, the input image data IN may be frame-rate converted to image data at an output frame frequency (for example, 200 Hz), which is 4 times the input frame frequency (for example, 50 Hz) and the input image signal IDAT, by duplicating the input image data IN of one frame to, for example, 4 frames. In this case, one frame for every 2 frames may be designated as a release frame 1′, 2′, 3′, or 4′ in order to prevent the release frame from being driven at a relatively low frequency and recognized as flicker. In this case, the frequency of the release frame is 100 Hz.

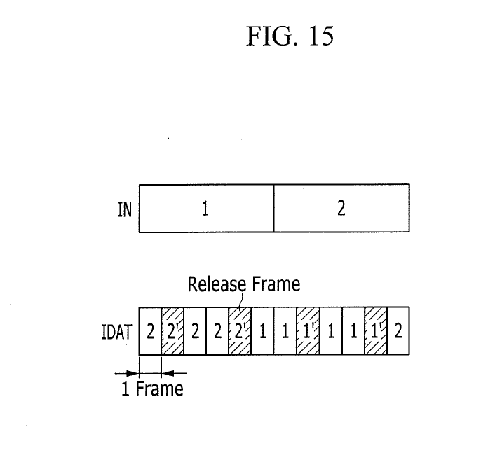

Referring to FIG. 15, the input image data IN may be input at an input frame frequency of, for example, 60 Hz. Further, the input image data IN may be frame-rate converted to image data at an output frame frequency (for example, 360 Hz), which is 6 times the input frame frequency (for example, 60 Hz) and the input image signal IDAT, by duplicating the input image data IN of one frame to, for example, 6 frames. In this case, one frame for every 3 frames may be designated as a release frame 1′ or 2′ in order to prevent the release frame from being driven at a relatively low frequency and recognized as flicker. In this case, the frequency of the release frame is 120 Hz.

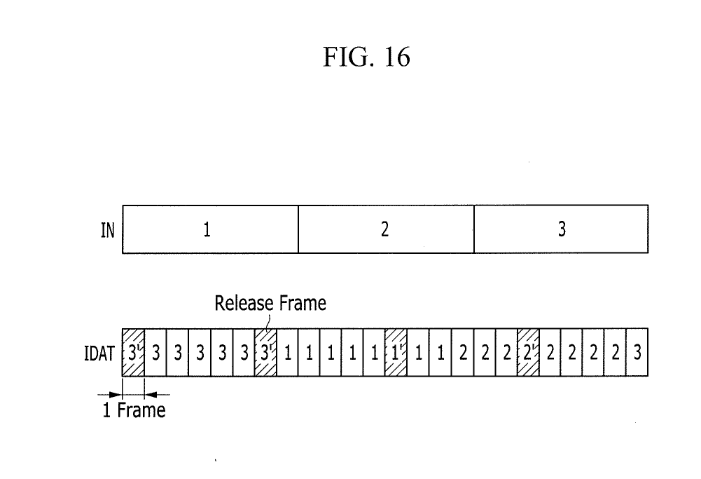

Next, referring to FIG. 16, the input image data IN may be input at an input frame frequency of, for example, 60 Hz. Further, the input image data IN may be frame-rate converted to image data at an output frame frequency (for example, 480 Hz), which is 8 times the input frame frequency (for example, 60 Hz) and the input image signal IDAT, by duplicating the input image data IN of one frame to, for example, 8 frames. In this case, one frame for every 6 frames or less may be designated as a release frame 1′, 2′, or 3′ in order to prevent the release frame from being driven at a relatively low frequency and recognized as flicker. In this case, the frequency of the release frame is 80 Hz or more.

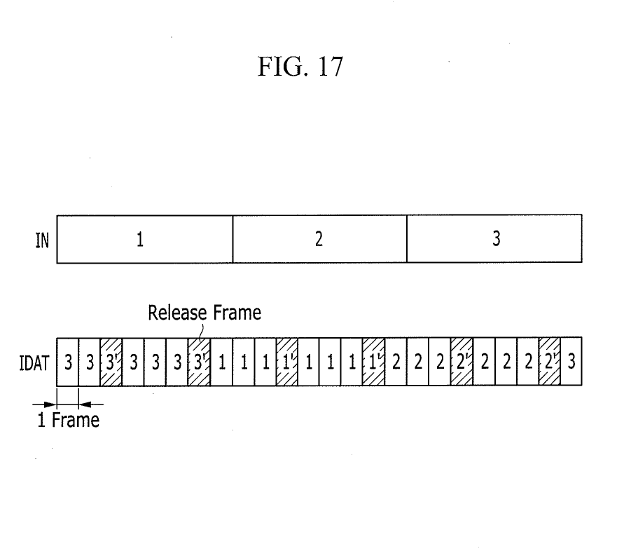

Next, referring to FIG. 17, the present exemplary embodiment is mostly the same as the aforementioned exemplary embodiment illustrated in FIG. 16, but FIG. 17 illustrates an example in which one frame is designated as the release frame 1′, 2′, or 3′ for every 4 frames of the frame-rate converted input image signal IDAT. In this case, the frequency of the release frame is 120 Hz.

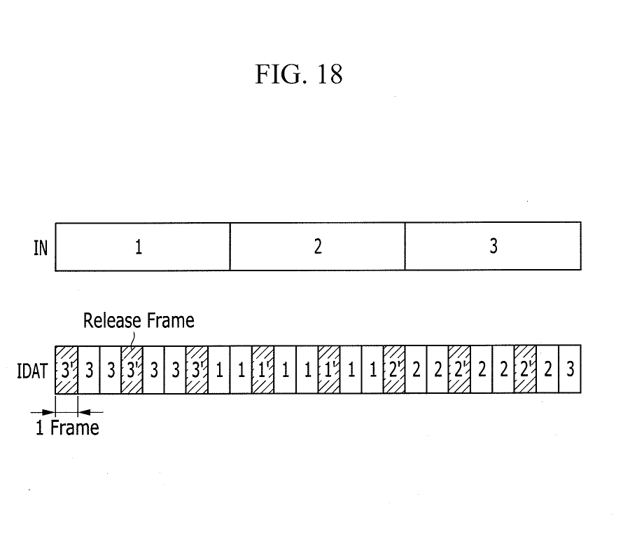

Next, referring to FIG. 18, the present exemplary embodiment is mostly the same as the aforementioned exemplary embodiment illustrated in FIG. 16, but FIG. 18 illustrates an example in which one frame is designated as the release frame 1′, 2′, or 3′ for every 3 frames of the frame-rate converted input image signal IDAT. In this case, the frequency of the release frame is 160 Hz.

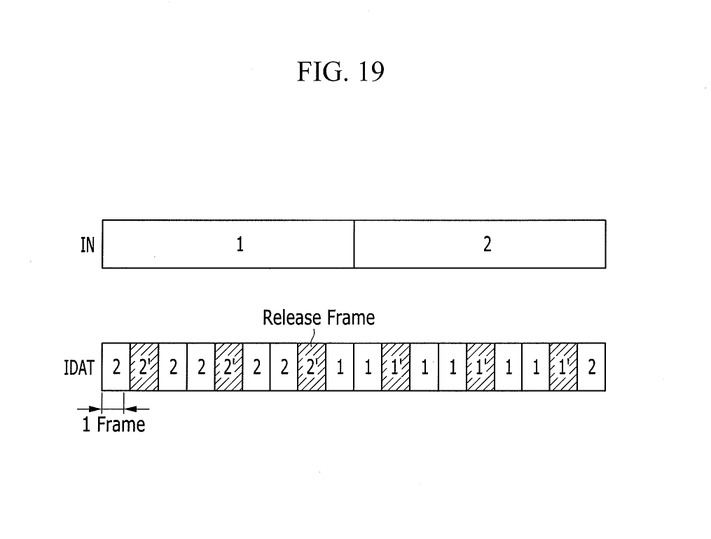

Last, referring to FIG. 19, the input image data IN may be input at an input frame frequency of 50 Hz, and the input image data IN of one frame may be duplicated to, for example, 9 frames. Accordingly, the input image data IN of one frame may be frame-rate converted to image data of the output frame frequency (for example, 450 Hz), which is 9 times the input frame frequency (for example, 60 Hz) and the input image signal IDAT. In this case, one frame for every 6 frames may be designated as a release frame in order to prevent the release frame from being recognized as flicker. In this case, a frequency of the release frame is 75 Hz or more. FIG. 19 illustrates an example in which one frame is designated as the release frame 1′ or 2′ for every 3 frames of the input image signal IDAT so that the frequency of the release frame is 150 Hz.

Additionally, the input frame frequency and the output frame frequency of the input image data IN may be varied. Particularly, since the frequency of the release frame is set to be substantially equal to or higher than 75 Hz, an image quality characteristic of the display device is improved. The display device may be driven so that the output frame frequency is substantially equal to or higher than 360 Hz, or alternatively, is equal to or higher than 480 Hz, in order to increase the frequency of the release frame.

While the above embodiments have been described in connection with the accompanying drawings, it is to be understood that the invention is not limited to the disclosed embodiments, but, on the contrary, is intended to cover various modifications and equivalent arrangements included within the spirit and scope of the appended claims.

What is claimed is:

1. A display device, comprising:
a memory configured to receive an input image data at a first frame frequency;
a frame rate controller configured to convert the input image data to an output image data, output at a second frame frequency higher than the first frame frequency, by duplicating the input image data to a plurality of frames;
a release frame inserting unit configured to substantially periodically designate release frames in the output image data to substantially remove a direct current (DC) bias from at least one continuous frame; and
a data compensator configured to compensate for a value of the output image data or determine the value of the output image data.

2. The display device of claim 1, wherein the release frame has a frequency of approximately 75 Hz or more.

3. The display device of claim 1, wherein the data compensator is further configured to determine the value of the output image data of the release frame based at least in part on a magnitude of the DC bias in a frame positioned between adjacent release frames.

4. The display device of claim 1, wherein the data compensator is further configured to determine a polarity of the output image data of the release frame based at least in part on a polarity of the DC bias in a frame positioned between adjacent release frames.

5. The display device of claim 4, wherein the polarity of the output image data of the release frame is opposite to the polarity of the DC bias in the frame positioned between the adjacent release frames.

6. The display device of claim 1, further comprising:
a display panel including a plurality of pixels; and
a backlight unit configured to provide light to the display panel,
wherein the backlight unit is configured to be turned off or decrease luminance during the release frame.

7. The display device of claim 1, further comprising:
a signal controller configured to i) receive the value of the output image data from the data compensator as an input image signal and ii) output an output image signal; and
a data driver configured to i) receive the output image signal from the signal controller, ii) convert the received output image signal to a data voltage, and iii) output the data voltage.

8. The display device of claim 1, wherein the data driver is configured to be driven by a column inversion driving method.

9. The display device of claim 1, wherein the data compensator is further configured to determine the value of the output image data of the release frame based at least in part on a magnitude of the DC bias in a frame positioned between adjacent release frames.

10. The display device of claim 1, wherein the data compensator is further configured to determine a polarity of the output image data of the release frame based at least in part on a polarity of the DC bias in a frame positioned between adjacent release frames.

11. The display device of claim 10, wherein the polarity of the output image data of the release frame is opposite to the polarity of the DC bias in the frame positioned between the adjacent release frames.

12. The display device of claim 1, further comprising:
a display panel including a plurality of pixels; and
a backlight unit configured to provide light to the display panel,
wherein the backlight unit is configured to be turned off or decrease luminance during the release frame.

13. The display device of claim 1, further comprising:
a signal controller configured to i) receive the value of the output image data from the data compensator as an input image signal, and ii) output an output image signal; and
a data driver configured to i) receive the output image signal from the signal controller, ii) convert the received output image signal to a data voltage, and iii) output the data voltage.

14. A method of driving a display device, comprising:
receiving an input image data at a first frame frequency;
converting the input image data to an output image data, output at a second frame frequency higher than the first frame frequency, by duplicating the input image data to a plurality of frames;
substantially periodically designating release frames in the output image data to substantially remove a direct current (DC) bias from at least one continuous frame; and
compensating for or determining a value of the output image data.

15. The method of claim 14, wherein the release frame has a frequency of approximately 75 Hz or more.

16. The method of claim 15, wherein the compensating includes determining the value of the output image data of the release frame based at least in part on a magnitude of the DC bias in a frame positioned between adjacent release frames.

17. The method of claim 15, wherein the compensating includes determining a polarity of the output image data of the release frame based at least in part on a polarity of the DC bias of a frame positioned between adjacent release frames.

18. The method of claim 17, wherein the polarity of the output image data of the release frame is opposite to the polarity of the DC bias in the frame positioned between the adjacent release frames.

19. The method of claim 15, wherein the display device includes a display panel including a plurality of pixels, and a backlight unit configured to provide light to the display panel, and wherein the method further comprises turning off or decreasing luminance of the backlight unit during the release frame.

20. The method of claim 15, further comprising:
receiving the output image data as an input image signal, and converting the received output image data to a data voltage.
